(19) United States
(12) Patent Application Publication
(10) Pub. No.: US 2022/0126764 A1
(43) Pub. Date: Apr. 28, 2022

(54) SKIN MEMBER

(71) Applicant: NIHON PLAST CO., LTD., Fujinomiya-shi (JP)

(72) Inventors: Yasuhiro Uchida, Shizuoka (JP); Naoko Tanaka, Shizuoka (JP); Misawo Sano, Shizuoka (JP); Takahiro Suwama, Shizuoka (JP)

(21) Appl. No.: 17/499,916

(22) Filed: Oct. 13, 2021

(30) Foreign Application Priority Data
Oct. 26, 2020 (JP) 2020-178732

(51) Int. Cl. B60R 13/02; D05B 93/00

(52) U.S. Cl. CPC B60R 13/02; D10B 2505/12; D05B 93/00

(57) ABSTRACT

There is provided a skin member having an improved appearance in a state of being attached to a base material. Skin member 12 includes a plurality of base fabrics 18, primary sewing section 20 which joins terminal portions of base fabric 18 and at least a part of which is disposed in a curved shape, secondary sewing section 22 which joins sewing region 21 of the terminal portion of each of base fabrics 18 by primary sewing section 20 to a surface of each of base fabrics 18 on a base material side, and pinking section 25 which is cut out in a zigzag shape on an end edge of sewing region 21 of base fabric 18 having a large curvature of primary sewing section 20, among the base fabrics. In pinking section 25, at least zigzag tip portions 25a and 25b are formed in an arc shape.

### CROSS REFERENCE TO RELATED APPLICATIONS

Japanese Patent Application No. 2020-178732 filed on Oct. 26, 2020, including description, claims, drawings, and abstract the entire disclosure is incorporated herein by reference in its entirety.

### TECHNICAL FIELD

The present invention relates to a skin member used by being attached to a base material.

### BACKGROUND ART

In the related art, in interior parts such as instrument panels of automobiles, there are those obtained by attaching a skin member such as leather to a base material made of synthetic resin. The skin member forms a stitch-like design by primary sewing and joining terminal portions of a plurality of base fabrics to each other, opening a sewing region thereof, and further secondary sewing to a surface of the base fabric, which is a base material side, and improves the appearance.

In a case where the primary sewing is disposed in a curved shape such as an arc shape, the sewing region of the base fabric on an inner peripheral side thereof has an excess and becomes an undulated state. In this case, even if the skin member is attached to the base material, the undulated sewing region cannot adhere to the base material and remains in an undulated state, and the appearance becomes poor.

In such a case, a method is generally known in which an end edge of the fabric on the inner peripheral side is cut out in a zigzag shape to form a pinking section, the remainder of the fabric is scraped, and the undulation is eliminated (for example, refer to PTL 1).

### CITATION LIST

### Patent Literature

### PTL 1

Japanese Patent Application Laid-Open No. 2000-54210 (page 2, FIG. 1)

### SUMMARY OF INVENTION

### Technical Problem

However, in a case of the configuration in which the skin member is attached to the base material, since a tip of the zigzag portion of the pinking section is sharp, in a case where the base fabric is a hard material such as leather, there is a concern that the base fabric of the skin member in which the tip of the zigzag portion is attached to the base material is pushed up, zigzag-like wrinkles occur on a design surface, and the appearance deteriorates.

The present invention has been made in view of such a point, and an object of the present invention is to provide a skin member having an improved appearance in a state of being attached to a base material.

### Solution to Problem

A skin member according to a first aspect is a skin member used by being attached to a base material, the member including a plurality of base fabrics, a first joining section which joins terminal portions of the base fabrics, and at least a part of which is disposed in a curved shape, a second joining section which joins a joining region of the terminal portion of each of the base fabrics by the first joining section to a surface of each of the base fabrics, which becomes a base material side, and a pinking section which is cut out in a zigzag shape on an end edge of the joining region of the base fabric having a large curvature of the first joining section, among the base fabrics, in which in the pinking section, at least a zigzag tip portion is formed in a curved shape.

The skin member according to a second aspect is a skin member according to the first aspect, in which the pinking section is formed in a curved shape.

### Advantageous Effects of Invention

According to the skin member according to a first aspect, since an excess of the end edge of the joining region of the base fabric having a large curvature of the first joining section is scraped by the pinking section, even if at least a part of the first joining section is disposed in a curved shape, the joining region is not undulated, the base fabric can be attached to the base material in an adhered state, and a zigzag tip portion of the pinking section is formed in a curved shape. Therefore, it is made difficult for the base fabric to be pushed up from a base material side due to the shape of the pinking section, zigzag-like fine irregularities hardly occur on the design side, and thus appearance can be improved in a state of attaching the skin member to the base material.

According to the skin member according to the second aspect, in addition to an effect of the skin member according to the first aspect, it can be made more difficult for the base fabric to be pushed up from the base material side due to the shape of the pinking section, and the appearance can be further improved in a state of attaching the skin member to the base material.

### BRIEF DESCRIPTION OF DRAWINGS

FIG. 1 is an enlarged plan view schematically showing a part of a skin member according to an embodiment of the present invention;

FIG. 2 is a perspective view showing a part of the skin member of the same as above; and

FIG. 3 is a cross-sectional view schematically showing a part of an interior part including the same skin member.

### DESCRIPTION OF EMBODIMENTS

Hereinafter, an embodiment of the present invention will be described with reference to drawings.

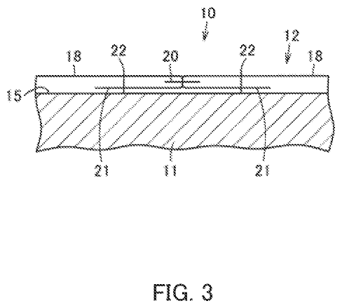

In FIG. 3, 10 is an interior part. Interior part 10 is used in a passenger compartment of an automobile, for example. Interior part 10 is an interior part for a vehicle used for an instrument panel, a garnish, an airbag cover, and the like of an automobile, for example.

Interior part 10 is configured by attaching skin member 12 to base material 11.

Base material 11 is formed of a member such as synthetic resin. Base material 11 includes covered surface section 15 having a predetermined area.

Skin member 12 is disposed to cover covered surface section 15. Skin member 12 includes a plurality of base fabrics 18. As base fabric 18, for example, leather such as natural leather or synthetic leather, or fabric is used. In base fabrics 18, a terminal portion is sewn and joined by primary sewing section 20 which is a first joining section, and sewing region 21 which is a joining region is overlapped on a main surface of base material 11 side (covered surface section 15 side), that is, a back surface side of base fabric 18, and is sewn and joined by secondary sewing section 22 which is a second joining section.

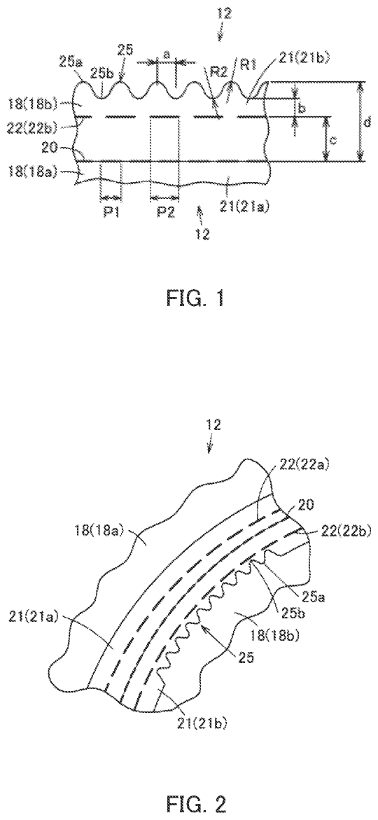

In the present embodiment, as shown in FIGS. 1 and 2, base fabric 18 is described as setting a pair of one base fabric 18a and other base fabric 18b, but the number of base fabrics 18 is not limited.

Primary sewing section 20 joins base fabrics 18 to each other. At least a part of primary sewing section 20 is disposed in a curved shape on a surface along covered surface section 15 (FIG. 3). That is, at least a part of primary sewing section 20 is curved in a direction intersecting an extending direction thereof. In the present embodiment, at least a part of primary sewing section 20 has an arc shape. In the illustrated example, primary sewing section 20 is disposed in an arc shape having a radius of curvature of 110 mm or less. In the present embodiment, for the sake of clarity, as shown in FIG. 2, only the matter in which one base fabric 18a becomes an outer peripheral side on which a curvature of primary sewing section 20 is small (the side on which a radius of curvature is large), and other base fabric 18b becomes an inner peripheral side on which a curvature of primary sewing section 20 is large (the side on which a radius of curvature is small) is explained, but in a case where primary sewing section 20 is formed in a wave shape, for example, the curvature of one base fabric 18a and other base fabric 18b changes in size depending on the bending direction of primary sewing section 20, any one of one base fabric 18a and other base fabric 18b is fixed to a large curvature side, and it is not limited to the configuration in which the other is fixed to a small curvature side.

Secondary sewing section 22 constitutes a stitch-like design on the design surface. Secondary sewing section 22 is separated from primary sewing section 20 toward the end edge of sewing region 21 at a constant or substantially constant interval. That is, in a case where primary sewing section 20 has a curved shape, secondary sewing section 22 is also disposed in the same curved shape. As shown in FIG. 1, in the present embodiment, pitch P2 of a stitch of secondary sewing section 22 is set to be larger than pitch P1 of a stitch of primary sewing section 20.

In the example shown in FIG. 2, in the present embodiment, secondary sewing section 22 is set to include one secondary sewing section 22a for joining one sewing region 21a to one base fabric 18a, and other secondary sewing section 22b for joining other sewing region 21b to other base fabric 18b.

Zigzag-like pinking section 25 is formed on an end edge of sewing region 21 on a side of base fabric 18 having a large curvature of primary sewing section 20, among base fabrics 18. In the illustrated example, pinking section 25 is formed on an end edge of other sewing region 21b of other base fabric 18b.

Pinking section 25 is formed by cutting out the end edge of sewing region 21 in a zigzag shape. In pinking section 25, both of tip portion 25a which is at least one folded section of the zigzag, that is, a convex apex, and tip portion 25b which is the other folded section of the zigzag, that is, a concave apex, are formed in a curved shape, and this forms a shape not having a sharp or corner portion. In the present embodiment, tip portions 25a and 25b of pinking section 25 are formed in an arc shape. In addition, in the illustrated example, pinking section 25 is formed in a curved shape in which the entirety is continuous, and has a wave shape in which arcs are alternately connected.

The arc shapes of zigzag tip portions 25a and 25b of pinking section 25 may be equal to or different from each other. As shown in FIG. 1, radii of curvature R1 and R2 of zigzag tip portions 25a and 25b of pinking section 25 are preferably 0.6 mm or more. In the present embodiment, radii of curvature R1 and R2 are set to 0.6 mm, respectively.

In addition, pitch a of zigzag of pinking section 25 is set so that the zigzag of pinking section 25 does not enter a sewing machine jig used when sewing primary sewing section 20. In the present embodiment, pitch a is set to 1.5 mm, for example.

In addition, distance b between tip portion 25b, which is the concave apex of the zigzag of pinking section 25, and secondary sewing section 22 is set so that secondary sewing section 22 does not fall into the zigzag of pinking section 25. In the present embodiment, distance b is set to 1.5 mm, for example.

In addition, in the present embodiment, distance c between secondary sewing section 22 and primary sewing section 20 is set to be equal to or more than half of distance d between primary sewing section 20 and tip portion 25a which is the convex apex of pinking section 25. In the illustrated example, distance c is set to 4 0 mm, for example, and distance d is set to 7.0 mm, for example.

These numerical values are not fixed, but may be set according to the type of base fabric 18 or the curvature of primary sewing section 20, and the shape of the sewing machine jig used at the time of sewing.

When forming skin member 12, first, the terminal portions of base fabrics 18a and 18b are sewn by primary sewing section 20 with the main surfaces on the design side overlapping each other.

Subsequently, sewing regions 21a and 21b generated by sewing of primary sewing section 20 are opened to the left and right with respect to primary sewing section 20 and superposed on base fabrics 18a and 18b, and these sewing regions 21a and 21b are sewn by secondary sewing section 22 with respect to base fabrics 18a and 18b.

Pinking section 25 is preferably formed on an end edge of other base fabric 18b in advance before being sewn by primary sewing section 20, but may be formed after being sewn by primary sewing section 20 or after being sewn by secondary sewing section 22.

In skin member 12 formed in this way, the excess of the end edge of other sewing region 21b of other base fabric 18b on the inner peripheral side of primary sewing section 20 is scraped by pinking section 25, even if primary sewing section 20 is disposed in a curved shape, other sewing region 21b is not undulated, other base fabric 18b can be attached to covered surface section 15 of base material 11 in an adhered state, zigzag tip portions 25a and 25b of pinking section 25 is formed in a curved shape, and in an arc shape in the present embodiment, and this forms a shape not having a sharp or corner portion. Therefore, it is made difficult for other base fabric 18b to be pushed up from base material 11 side due to the shape of pinking section 25. Therefore, even if other base fabric 18b is a hard material, zigzag-like fine irregularities hardly occur on the design side. Therefore, the appearance of skin member 12 in a state of being attached to base material 11 can be improved.

In addition, by making the zigzag of pinking section 25 be in a curved shape, it can be made more difficult for other base fabric 18b to be pushed up from base material 11 side due to the shape of pinking section 25, and the appearance can be improved in a state of attaching skin member 12 to base material 11.

In the embodiment, tip portions 25a and 25b of pinking section 25 are not limited to be in an arc shape, respectively, but may be in an optional curved shape, such as an elliptically curved shape, a quadratically curved shape, a sinusoidal shape, and a cosine wave shape, for example.

In addition, each joining section is not limited to sewing, and any optional joining means may be used.

### INDUSTRIAL APPLICABILITY

The present invention is suitably used as a skin member for interior parts of automobiles, for example.

### REFERENCE SIGNS LIST

11 Base material
12 Skin member
18 Base fabric
20 Primary sewing section which is a first joining section
21 Sewing region which a joining region
22 Secondary sewing section which is a second joining section
25 Pinking section
25a, 25b Tip portion

1. A skin member used by being attached to a base material, the member comprising:
a plurality of base fabrics;
a first joining section which joins terminal portions of the base fabrics, and at least a part of which is disposed in a curved shape;
a second joining section which joins a joining region of the terminal portion of each of the base fabrics by the first joining section to a surface of each of the base fabrics, which becomes a base material side; and
a pinking section which is cut out in a zigzag shape on an end edge of the joining region of the base fabric having a large curvature of the first joining section, among the base fabrics,
wherein in the pinking section, at least a zigzag tip portion is formed in a curved shape.

2. The skin member according to claim 1,
wherein the pinking section is formed in a curved shape.
